(19) United States
(12) Patent Application Publication
(10) Pub. No.: US 2021/0053304 A1
(43) Pub. Date: Feb. 25, 2021

(54) SELECTIVE COMMINGLED FIBER BUNDLE PREFORM HAVING INTEGRAL OPTICAL FIBER STRAIN SENSOR

(71) Applicant: COATS & CLARK, INC., Charlotte, NC (US)

(72) Inventor: Probir Kumar Guha, Bloomfield Hills, MI (US)

(73) Assignee: COATS & CLARK, INC., Charlotte, NC (US)

(21) Appl. No.: 16/998,073

(22) Filed: Aug. 20, 2020

Related U.S. Application Data
(60) Provisional application No. 62/889,302, filed on Aug. 20, 2019.

(51) Int. Cl. B29C 70/88; B29B 11/16; B29B 11/04; B29C 70/48; G01K 11/32

(52) U.S. Cl. CPC B29C 70/88; B29B 11/16; B33Y 30/00; B29C 70/48; G01K 11/32; B29B 11/04

(57) ABSTRACT

A form for a vehicle component includes a commingled fiber bundle composed of thermoplastic fibers and a reinforcement fiber. The reinforcement fiber being glass fibers, aramid fibers, carbon fibers, or a combination thereof. The commingled fiber bundle is laid out in a two-dimensional base layer that defines a shape of the form. An optical fiber is stitched to the commingled fiber bundle. A method of forming a unitary reinforced composite component having a sensor system includes the form being placed onto a mold platen. The preform is heated to promote fusion of the thermoplastic fibers therein. The preform is cooled until solidified with contours of the component. The vehicle component is then removed from the mold platen.

### RELATED APPLICATIONS

This application claims priority benefit of U.S. Provisional Application No. 62/889,302 filed 20 Aug. 2019; the contents of which are hereby incorporated by reference.

### FIELD OF THE INVENTION

The present invention in general relates to composite vehicle components and in particular, to fiber preforms with an integral optical fiber strain sensor for unitary reinforced composite based vehicle components.

### BACKGROUND OF THE INVENTION

Weight savings in the automotive, transportation, and logistics based industries has been a major focus in order to make more fuel-efficient vehicles both for ground and air transport. In order to achieve these weight savings, light weight composite materials have been introduced to take the place of metal structural and surface body components and panels. Composite materials are materials made from two or more constituent materials with significantly different physical or chemical properties, that when combined, produce a material with characteristics different from the individual components. The individual components remain separate and distinct within the finished structure. A composite material may be preferred for many reasons: common examples include materials which are stronger, lighter, or less expensive when compared to traditional materials.

As part of an effort to reduce vehicle weight and ease of manufacture vehicle manufacturers have moved towards composite material vehicle components. These composite materials include a matrix material that surrounds and supports the reinforcement materials by maintaining their relative positions. The reinforcements impart their special mechanical and physical properties to enhance the matrix properties. A synergism produces material properties unavailable from the individual constituent materials, while the wide variety of matrix and strengthening materials allows the designer of the product or structure to choose an optimum combination.

The use of fiber and particulate inclusions to strengthen a matrix is well known to the art. Well established mechanisms for the strengthening include slowing and elongating the path of crack propagation through the matrix, as well as energy distribution associated with pulling a fiber free from the surrounding matrix material. In the context of sheet molding composition (SMC) formulations, bulk molding composition (BMC) formulations, and resin transfer molding (RTM); hereafter referred to collectively as “molding compositions,” fiber strengthening has traditionally involved usage of chopped glass fibers. There is a growing appreciation in the field of molding compositions that replacing in part, or all of the glass fiber in molding compositions with carbon fiber can provide improved component properties.

Tailored Fiber Placement (TFP) is a textile manufacturing technique in which fibrous material is arranged on another piece of base material and is fixed with an upper and lower stitching thread on the base material. The fiber material can be placed in curvilinear patterns of a multitude of shapes upon the base material. Layers of the fiber material may be built up to produce a two-dimensional fiber preform insert, which may be used as an insert overmolding or resin transfer process to create composite materials.

Resin transfer molding or overmolding (hereafter referred to synonymously as “RTM”) is a process in which the fiber preform in placed in a mold where a melt processible material is molded directly into the insert. Melt processible materials typically used in overmolding include elastomers and thermoplastics. The major overmolding processes includes insert molding and two-shot molding. Materials are usually chosen specifically to bond together, using the heat from the injection of the second material to form that bond that avoids the use of adhesives or assembly of the completed part, and results in a robust composite material part with a high-quality finish.

Commercially produced composites often use a polymer matrix material that is either a thermoplastic or thermoset resin. There are many different polymers available depending upon the starting raw ingredients which may be placed into several broad categories, each with numerous variations. Examples of the most common categories for categorizing polymers include polyester, vinyl ester, epoxy, phenolic, polyimide, polyamide, polypropylene, PEEK, and others.

As vehicles are increasingly platforms for ever more complex computerized systems, there is a need for sensors throughout the vehicle and its associated components. However, the complexity of such sensor systems throughout a vehicle increases the weight of the vehicle, increases the complexity of a vehicle electrical harness, and increases the time needed for installation. Traditionally, sensors are strategically placed in preselected positions around a vehicle and joined to structural components during vehicle assembly. Sets of wires are cut to predetermined lengths and tied into bundles with connectors to join the sensors to other electrical components of the vehicle. Such sensors and wiring harnesses have become increasingly impractical and time consuming to couple to not only to the vehicle, but also electrical wiring and central processing units (CPUs). Traditional sensor systems are subjected to extreme environments also suffer from vibrationally induced wear caused by vehicle operation. The failure of such sensors or shorting of a wire within an electrical harness is difficult to locate and repair.

Thus, there exists a need to form a vehicle component having an sensor system integral therein.

### SUMMARY OF THE INVENTION

A form for a vehicle component includes a commingled fiber bundle composed of thermoplastic fibers and a reinforcement fiber. The reinforcement fiber being glass fibers, aramid fibers, carbon fibers, or a combination thereof. The commingled fiber bundle is laid out in a two-dimensional base layer that defines a shape of the form. An optical fiber is stitched to the commingled fiber bundle.

A method of forming a unitary reinforced composite component having a sensor system includes the form being placed onto a mold platen. The preform is heated to promote fusion of the thermoplastic fibers therein. The preform is cooled until solidified with contours of the component. The vehicle component is then removed from the mold platen.

### BRIEF DESCRIPTION OF THE DRAWINGS

The subject matter that is regarded as the invention is particularly pointed out and distinctly claimed in the claims at the conclusion of the specification. The foregoing and other objects, features, and advantages of the invention are apparent from the following detailed description taken in conjunction with the accompanying drawings in which:

FIG. 1 is a schematic illustrating a selective commingled fiber bundle positioning (SCFBP) form created from a continuous fiber bundle inclusive of optical fiber according to the present invention;

FIG. 2 is a cross section representation of a SCFBP form, where C stands for a carbon fiber rich commingled fiber bundle and G stands for glass fiber rich commingled fiber bundle, in accordance with embodiments of the invention;

FIGS. 3A-3C are a sequence of schematic steps of processing an inventive SCFBP form into a vehicle component by melting thermoplastic content of the SCFBP form;

FIG. 4 is a schematic of a vehicle having a sensor system according to embodiments of the present invention;

FIG. 5 is a graph showing a Brillouin frequency shift caused by strain in an optical fiber according to embodiments of the present invention;

FIG. 6 is a graph showing a BOTDR measurement procedure implemented in embodiments of the present disclosure;

FIG. 7 shows a schematic drawing of a BOTDR configuration according to embodiments of the present disclosure; and

FIG. 8 shows a schematic drawing of a BOTDR distributed optical fiber strain sensor.

### DESCRIPTION OF THE INVENTION

The present invention has utility as a unitary reinforced composite based panel component, and methods of construction thereof inclusive of optical fiber. A vehicle component is prepared with resort to selective commingled fiber bundle positioning (SCFBP) to selectively place co-mingled fibers that are in some inventive embodiments enriched in carbon fiber as a reinforcement relative to other region that rely on a relatively higher percentage of glass fiber reinforcement while internalizing optical fiber within the vehicle part. By internalizing an optical fiber within a vehicle part, vehicle assembly is simplified, capabilities of sensor systems are increased, and vibrationally induced wear and environmentally induced wear observed on traditional sensors is eliminated.

In specific inventive embodiments, commingled fibers of thermoplastics, and reinforcing fibers of glass, carbon, polyaramid, or a combination thereof are used to form a yarn that has predictable strength, and where the ratio of different fiber types is varied to create different properties along a given length. The commingled fiber-based yarn may be used in the formation of the SCFBP forms, and are able to be embroidered directly into complex shapes thereby eliminating trimming waste and inefficient usage of comparatively expensive carbon fiber. In specific inventive embodiments, SCFBP forms include from 3 to 20 layers that vary in fiber types in three dimensions (3D). Optical fiber is also stitched by the SCFBP process into the form to create pre-selected pathways. The final panel is them formed by melting thermoplastic fibers within the SCFBP form in contact with at least one mold platen complementary to the finished vehicle component to form a vehicle panel such as a dashboard, body panel, door component, roof components, or decklids.

It is to be understood that in instances where a range of values are provided that the range is intended to encompass not only the end point values of the range but also intermediate values of the range as explicitly being included within the range and varying by the last significant figure of the range. By way of example, a recited range of from 1 to 4 is intended to include 1-2, 1-3, 2-4, 3-4, and 1-4.

SCFBP-technology offers several advantages including varying the angle of fiber positioning during the lay-up process freely between 0 and 360°; repeated fiber positioning on the same area allows for local thickness variations in the fiber form suited for a fiber composite component; the conversion of the desired fiber orientation in a fiber positioning pattern for an embroidery machine requires minor development times and costs; the process allows a near-net-shape production, which results in low waste and optimal fiber exploitation; and the ability to process a variety of fibers such as natural, glass, aramid, carbon (high strength and high modulus) and ceramic fibers.

As used herein, a veil includes woven sheets, non-woven sheets, and films of thermoplastics, glass, or aramids; or woven sheets, non-woven sheets of carbon fibers.

As used herein, any reference to weight percent or by extension molecular weight of a polymer is based on weight average molecular weight.

As used herein, the term melting as used with respect to thermoplastic fibers or thread is intended to encompass both thermofusion of fibers such that a vestigial core structure of separate fibers is retained, as well as a complete melting of the fibers to obtain a homogenous thermoplastic matrix.

Commingled fibers as a roving are made up of commingled reinforcing fibers, illustratively including those made of carbon, glass, or aramid fibers, and thermofusible fibers which serve to provide a matrix in a composite material made of both reinforcing and matrix fibers. The matrix fibers, being of a thermofusible nature may be formed from material such as, for example, polyamide, polypropylene, polyester, polyether ether ketone, polybenzobisoxazole, or liquid crystal polymer. The reinforcing fibers may also be of a material that is meltable with the proviso that melting occurs at a temperature which is higher than the matrix fibers so that, when both fibers are used to create a composite, at the temperature point at which melting of the matrix fibers occurs, the state of the reinforcing fibers is unaffected.

The commingled fibers used in the present invention are composed of thermoplastic fibers and a reinforcement fiber. Thermoplastic fibers operative herein illustratively include, polypropylenes, polyamides, polyesters, polyether ether ketones, polybenzobisoxazoles, polyphenylene sulfide; block copolymers containing at least of one of the aforementioned constituting at least 40 percent by weight of the copolymer; and blends thereof. The thermoplastic fibers are appreciated to be recycled, virgin, or a blend thereof. The thermoplastic fibers in a commingled fiber bundle constitute from 20 to 80 weight percent of the commingled fibers in the present invention.

The reinforcement fibers in a commingled fiber bundle being glass fibers, polyaramid, carbon fibers, or a combination of any of the aforementioned. It is appreciated that the commingled fibers are either parallel to define a roving or include at some fibers that are helically twisted to define a yarn. It is appreciated that the physical properties of reinforcing fibers retained in a helical configuration within a fixed matrix of a completed vehicle component are different than those of a linear configuration, especially along the reinforcing fiber axis. The relative number of reinforcing fibers relative to the thermoplastic fibers is highly variable in the present invention in view of the disparate diameters of glass fibers, polyaramid fibers, and carbon fibers.

The optical fiber is stitched into the preform. The optical fiber can be included as a fiber in the commingled fiber bundle or may be separately stitched to the commingled fiber bundle via a separate stitching operation. According to embodiments, the optical fiber is a glass or plastic material. The optical fiber has a melting temperature which is higher than melting temperature of the matrix fibers and/or the reinforcing fibers so that at the temperature point at which melting of the matrix fibers and/or the reinforcing fibers occurs, the state of the optical fibers is unaffected. According to embodiments, the optical fiber is a continuous optical fiber having first end and a second end. According to embodiments, the optical fiber includes a plurality of discrete portions of optical fiber that emanate from the same location at one end and each terminate at a second end located in a plurality of locations throughout a vehicle component. According to embodiments, the optical fiber is coated in an ultraviolet-curable resin. According to embodiments, the optical fiber has a diameter of 0.25 mm.

An inventive form is created by laying out one or more commingled fiber bundles on a substrate as a two-dimensional base layer that defines a shape of the form with stitching applied to retain the commingled fibers in a desired placement on the substrate. As is conventional to SCFBP, the substrate can be removed after production of the form, else it is retained and thereby incorporated into the resulting vehicle component. In certain inventive embodiments, the stitching is a thermoplastic thread. The thermoplastic thread in some inventive embodiments is formed of the same thermoplastic present in the commingled fiber bundle. It is appreciated that the thread diameter and melting temperature of the thread used for stitching are variables that are readily selected relative to the properties of commingled fiber bundle. A first end and/or a second end of the optical fiber extends from the inventive preform such that the ends of the optical fiber are exposed and accessible for connection to other sensor system components or to the optical fibers of other vehicle components.

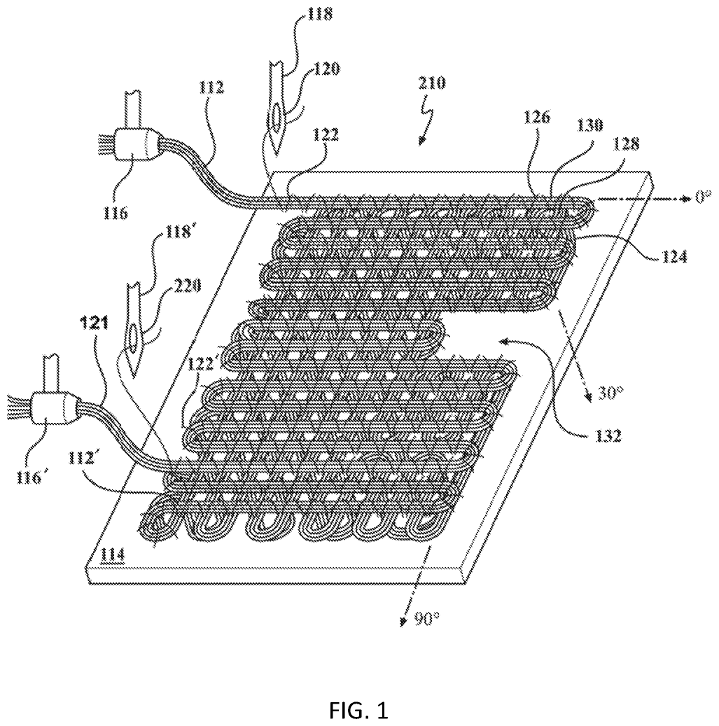

As shown in FIG. 1, an inventive form, shown generally at 210, is in the process of being created. The commingled fiber bundle 112 is conveyed to a substrate 114 by a guide pipe 116 to lay out the commingled fiber bundle 112 in predetermined pattern on the substrate 114. A conventional sewing machine head operating a needle 118 with a top thread 120 tacks the commingled fiber bundle 112 with stitches 122. A bobbin below the substrate 114, includes a bobbin with a lower thread are not shown, and are conventional to sewing machines. The top thread 120 and the bottom thread are thermoplastic threads. In certain inventive embodiments, the commingled fiber bundle 112 is laid out in a base layer 124 in generally parallels lines with a given orientation. Switchback turn regions 126 are commonly used to lay out parallel lines of commingled fiber bundle 112. A base layer 124 has an orientation of 30 degrees, while a first successive layer 128, and a second successive layer 130 have orientations of 90 degrees and 0 degrees, respectively. This is best seen in the notch region 132 in the form 210. A second conventional sewing machine head′ operating a needle 118′ with a top thread 220 tacks an optical fiber 121 with stitches 122′. A second bobbin below the substrate 114, includes a bobbin with a lower thread are not shown, and are conventional to sewing machines. The top threads 120 and 220, can be the same or different and likewise the bottom threads. The needle 118 in FIG. 1 is devoted to only applying a uniform commingled fiber bundle 112. While only two separate sewing heads are shown in FIG. 1, it should be appreciated that additional sewing heads are readily used to simultaneous stitch commingled fiber bundles to create a form or to vary the amount or type of reinforcing fiber relative to the bundle 112. This being especially the case when the form is for a large area form as might be employed in a vehicle component such as a floor. According to embodiments the bundle 112 includes an optical fiber, which is stitched to the substrate 114 and the successive layers 128, 130 within the bundle 112.

As a result of the present invention, the form 210 includes specific features such as the notch region 132 that conventionally would be cut from a base piece. In this way, the present invention eliminates the cutting step, as well as the associated waste generation while including optical fiber within the form, which remains continuous given the omission of any cutting step. In addition to the substantially linear pattern of commingled fiber bundle and optical fiber positioning depicted in FIG. 1 with interspersed switchbacks, it is appreciated that other patterns operative herein illustratively include spirals, and any space filling curve such as a Peano curve, dragon curve, or Sierpinksi curve.

If zero degrees is defined as the long axis of the base layer 124, the subsequent layers are overlaid at angles of 0-90°. For example, an angular displacement between adjacent layers is 45° resulting in a 0-45-90-45-0 pattern of layers. Further specific patterns illustratively include 0-45-90-45-0, 0-45-60-60-45 0, 0-0-45-60-45 0-0, 0-15-30-45-60-45-30-15 0, and 0-90-45-45-60-60-45-45-90-0. While these exemplary patterns are for from 5 to 10 layers of directional SCFBP, it is appreciated that the form 210 may include from 3 to 20 layers. It is appreciated that the form layers may be symmetrical about a central layer, in the case of an odd number of layers, or about a central latitudinal plane parallel to the players.

The stitching 122 or 122′ is applied with a preselected tension, stitching diameter, stitch spacing. The stitching 122 or 122′ is typically present in an amount of from 0.1 to 7 weight percent of the commingled fiber bundle 112′.

While FIG. 1 only shows three layers, it is appreciated that a form 210 is readily formed with up to 20 layers with the only technical limit being the length of the travel of the needle 118.

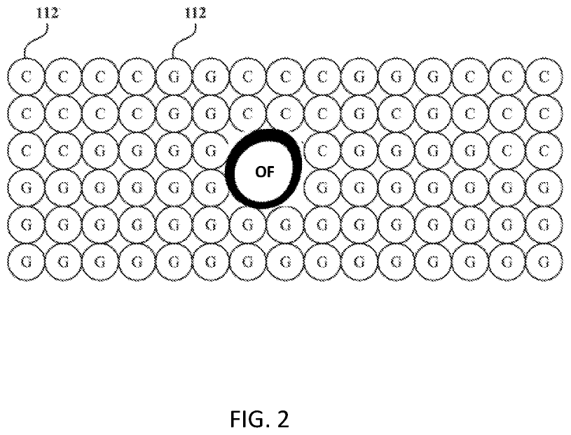

A cross-sectional view of an exemplary form similar to form 210 is shown in FIG. 2 with seven layers, where C denotes a carbon fiber enriched commingled fiber bundle 112, G denotes a carbon fiber depleted commingled fiber bundle 112 to illustrate regions of selective toughening to enforce the edges and center of the form, and OF denotes optical fiber 121. In this way carbon fiber is used efficiently to toughen while the part includes electrical wiring. In contrast to the form 210, with adjacent layers varying in angle, FIG. 2 shows the adjacent layers parallel for visual clarity. No stitches are shown for visual clarity. It will also be understood that the optical fiber 121 need not be near the center of the preform as shown in FIG. 2.

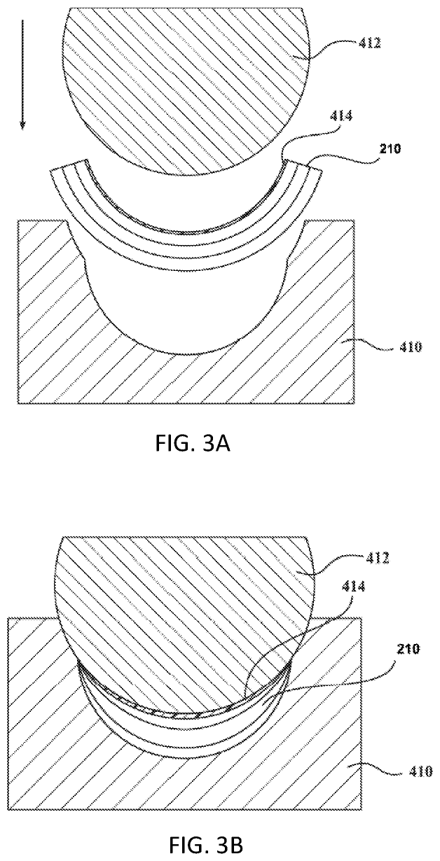

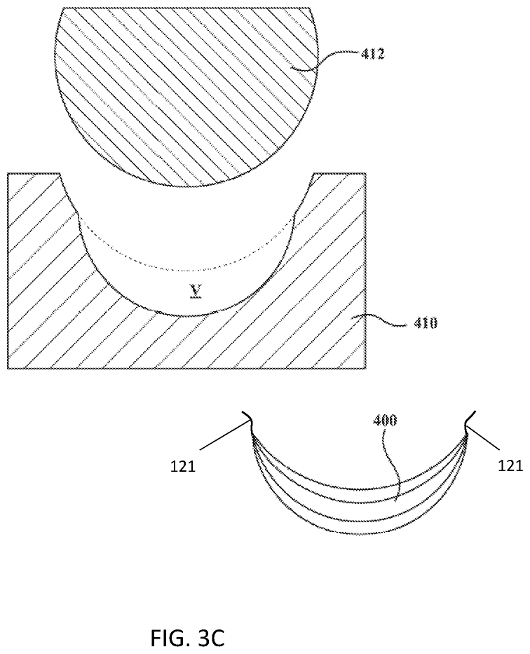

FIGS. 3A-3C are a series of schematics showing melt formation of a vehicle component 400. In FIG. 3A, form 210 is intended to be brought into simultaneous contact with opposing mold platens 410 and 412 that define a cavity volume, V. The volume V corresponding in shape to the desired vehicle component. By selectively heating one or both of the platens 410 or 412 to a temperature sufficient to melt the thermoplastic content of the form 210, but not the optical fiber 121, a vehicle component is formed upon cooling the mass compressed within the platens 410 and 412 by temperature and pressure, as shown in FIG. 3B. In a specific inventive embodiment, a thermoplastic veil 414 is in contact one or both platens 410 and 412 to create a skin on the resulting vehicle component. Upon opening the volume V, a completed vehicle component 400 is removed, as shown in FIG. 3C. As shown in FIG. 3C, a first end and a second end of the optical fiber 121 extends from the vehicle component 400 formed from an inventive preform such that the ends of the optical fiber 121 are exposed and accessible for connection to other sensor system components or to the optical fibers of other vehicle components, such as a Brillouin optical time-domain reflectometer (BOTDR) onboard a vehicle, which according to embodiments is configured to provide data to a computer onboard the vehicle.

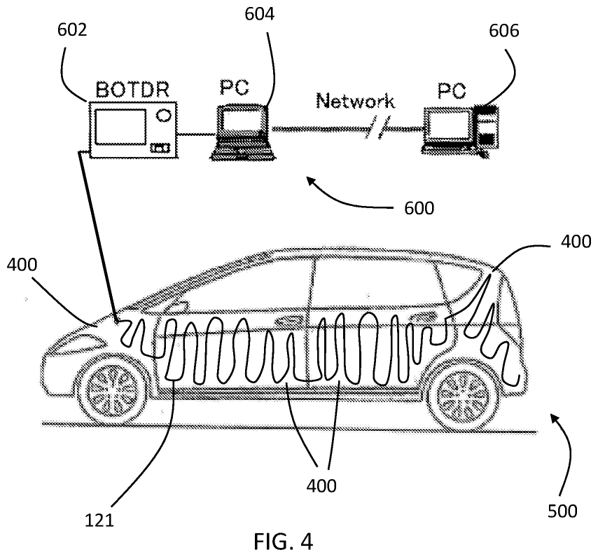

FIG. 4 shows a vehicle 500 having a sensor system 600 according to embodiments of the present invention. The sensor system 600 includes the optical fiber 121 positioned within the vehicle components 400 that make up the vehicle 500 and a Brillouin optical time-domain reflectometer (BOTDR) 602 onboard the vehicle. In FIG. 4, the optical fiber is shown for clarity of the invention, however, it will be understood that the optical fiber is embedded within the firber preform of each vehicle component. The sensor system 600 operates utilizing Brillouin scattered light, whose frequency depends on the longitudinal strain caused in the optical fiber, thus allowing the distributed strain along the optical fiber to be measured. According to embodiments a pulsed light is launched into only one end of the optical fiber 121, and Brillouin backscattered light caused by the pulsed light is observed at the same end. The BOTDR 602 determines the position of strain in the fiber 121 by using the time interval between launching the pulsed light and observing the scattered light. The spatial resolution is determined by the width of the pulse launched into the optical fiber 121 as with an ordinary OTDR.

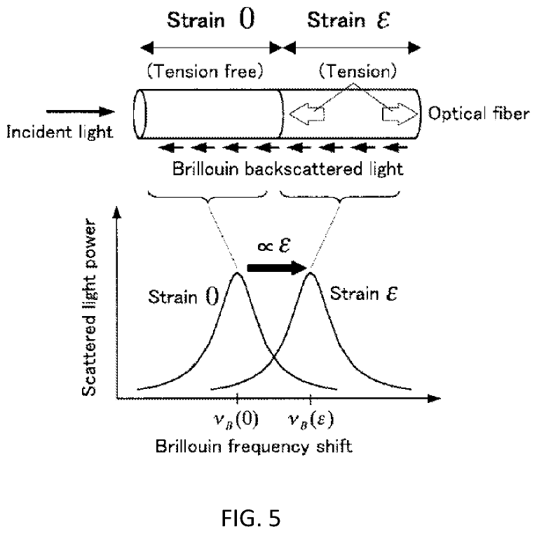

The interaction between lightwaves incident on an optical fiber and acoustic phonons generates Brillouin scattered light as backscattered light that propagates in the direction opposite to incident lightwaves. Because the phonons decay exponentially, the Brillouin scattered light spectrum is Lorentzian in form. The frequency at which peak power is obtained in the spectrum is shifted about 11 GHz from the incident lightwave frequency at a wavelength of 1.55 μm. This amount of frequency shift is called a Brillouin frequency shift, ν_{B}. If longitudinal strain ε occurs in the optical fiber, the Brillouin frequency shift ν_{B} changes in proportion to that strain, as shown in FIG. 5. This relation can be expressed as shown in Equation 1 wherein the coefficient dν_{B}/d_{ε} is approximately given by Equation 2.

$$\begin{matrix}{v}_{B} ( ɛ ) = {v}_{B} ( 0 ) + \frac{{dv}_{B} ( ɛ )}{d ɛ} \cdot ɛ & Equation 1 \\ \frac{{dv}_{B}}{d ɛ} = 0.5 GHz ( \text{/} \% strain ) & Equation 2\end{matrix}$$

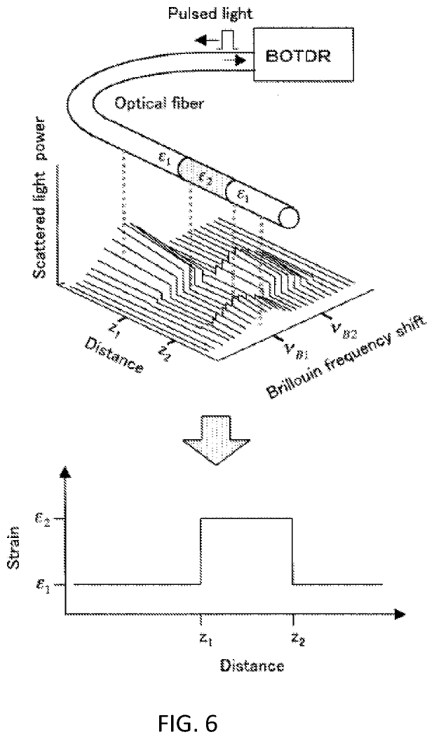

To obtain the distributed strain, that is, distributed ν_{B} along an optical fiber, the BOTDR observes the distribution of the Brillouin scattered light spectra along the optical fiber by utilizing the OTDR technique as shown in FIG. 6. The pulsed light is launched at one end of an optical fiber, and the BOTDR receives the Brillouin backscattered light at the same end using time-domain analysis. Therefore, the distance Z from the position where pulsed light is launched to the position where the scattered light is generated can be determined using Equation 3, which employs the time interval T between launching the pulsed light and receiving the scattered light at the end of the optical fiber.

$$Z = \frac{cT}{2 n} \qquad Equation 3$$

Here c is the light velocity in a vacuum and n is the refractive index of the optical fiber. To obtain the spectrum of the Brillouin scattered light, repeated measurements are made, in the manner described above, in which the incident light is slightly changed in relation to the spectrum width. As a result, a large number of power distributions of the Brillouin scattered light are obtained at different frequencies, as shown in FIG. 6. This allows one to obtain the scattered light spectrum at any position along the optical fiber from these groups of waveforms. This spectrum is fit to a Lorentzian curve and the frequency yield peak power, that is, ν_{B}, is used in the fitted curve to calculate the strain at that position. In this way, the strain distribution along the optical fiber is obtained from the observed spectra by using Equations 1-3. In FIG. 6, the correspondence between the strains ε₁ 1, ε₂ and the Brillouin frequency shifts ν_{B1}, ν_{B2}, respectively, are observed. In actual measurements, the coefficient dν_{B} (ε)/dε and the Brillouin frequency shift in the tension-free section, ν_{B} (0), both in Equation 1, are measured beforehand, and the frequency shift is converted to strain.

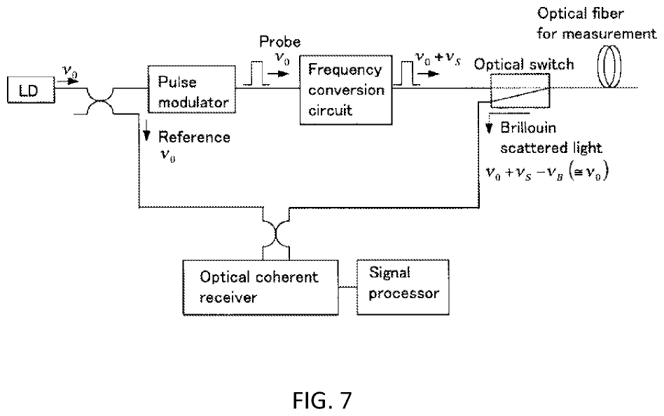

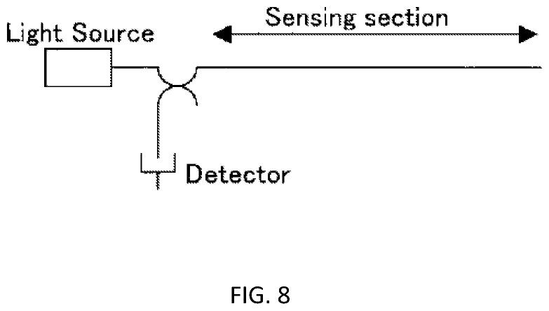

The configuration of the measuring equipment is shown in FIG. 7 and FIG. 8. The light source is a semiconductor laser (DFB-LD) of optical frequency ν₀. The light so produced is split by an optical coupler into a probe light and a reference light. The probe light is first subjected to pulse modulation and then passed to a frequency-conversion circuit based on a frequency-modulation function by an acousto-optical modulator. This circuit increases the frequency of the probe light by a frequency ν_{S} approximately equal to a Brillouin frequency shift ν_{B}≅11 GHz at a wavelength of 1.55 μm. The probe light is then launched into the optical fiber targeted for strain measurement. Here, as the power of the Stokes light shifted to the lower frequency side by ν_{B} is generally higher than that of the anti-Stokes light shifted to the higher frequency side by ν_{B}, this equipment observes only the Stokes light. Notably, the Stokes light frequency is close to the reference light frequency (ν₀+ν_{S}−ν_{B}≅ν₀) because the former shifted to the lower frequency side by ν_{B} from the incident light frequency ν₀+ν_{S}. Therefore, this Stokes light is mixed with the reference light and homodyne detection is performed at the optical coherent receiver. Notably, fluctuation in the light polarization state has a significant effect on measurement accuracy, and this effect is reduced by randomizing the polarization states in both the probe and reference lights.

Next, by slightly changing the amount of frequency conversion ν_{S} in the frequency conversion circuit, for example in 10 MHz increments, and by repeating the measurement the Brillouin scattered light spectra is obtained at any position along the optical fiber. The obtained spectra are then subjected to signal processing and converted to the strain distribution over distance.

The spatial resolution in these measurements, in other words, the distance information included in one item of the strain data at a given position, is decided in the same way as with the OTDR technique, that is, by the pulse width of the incident light. The spatial resolution ΔZ is expressed using a given pulse width τ as shown in Equation 4, where c is the light velocity in a vacuum and n is the refractive index of the optical fiber. At present, the pulse width with this measurement equipment is 10 ns, which corresponds to a spatial resolution of 1 m. The measurement accuracy, which is defined as the maximum variation of the measured strain in a strain-free section is ±0.003%.

$$Δ Z = \frac{c τ}{2 n} \qquad Equation 4$$

Because the BOTDR is capable of measuring continuous strain over the length of the optical fiber, the sensor system of the present invention provides a damage detection system for the vehicle that is light weight and easy to manufacture and implement given that it is integral with the fiber preform that forms a composite vehicle component. As shown in FIG. 4, the optical fiber 121 embedded in the fiber preforms that form the composite vehicle components is connected to the BOTDR 602, which in turn communicates with the computer onboard the vehicle 604. The BOTDR senses and collects strain data from the optical fiber, which is then communicated to and analyzed by the onboard computer. The onboard computer 604 analyzes the data to determine if the sensed strain is higher than any of potentially numerous thresholds. The thresholds may vary based on location of the sensed strain, vehicle operating conditions, or the value of the sensed strain, for example. When a given sensed strain exceeds a given threshold, the onboard computer 604 executes a corresponding command. Upon determining that a vehicle component is experiencing or has experienced a strain above a given threshold, the onboard computer 604a can execute a command to another vehicle system. For example, the command may be to stiffen the chassis, reduce the speed of the vehicle, deploy an airbag, call for emergency services, release a vehicle component such as a battery from the vehicle, or deploy a fire retardant or inert gas blanket to prevent or abate a fire.

The foregoing description is illustrative of particular embodiments of the invention, but is not meant to be a limitation upon the practice thereof. The following claims, including all equivalents thereof, are intended to define the scope of the invention.

1. A form for a vehicle component comprising:
a commingled fiber bundle composed of thermoplastic fibers and a reinforcement fiber, said reinforcement fiber being glass fibers, aramid fibers, carbon fibers, or a combination thereof, said commingled fiber bundle laid out in a two-dimensional base layer that defines a shape of the form; and
an optical fiber stitched to said commingled fiber bundle.

2. The form of claim 1 wherein said optical fiber is configured to be used with a Brillouin optical time-domain reflectometer (BOTDR) onboard a vehicle.

3. The form of claim 2 wherein said BOTDR is configured to provide data to a computer onboard the vehicle.

4. The form of claim 1 wherein said optical fiber is coated in an ultraviolet-curable resin.

5. The form of claim 1 wherein said optical fiber has a diameter of 0.25 mm.

6. The form of claim 1 wherein the reinforcement fiber is exclusively only the glass fibers.

7. The form of claim 1 wherein the reinforcement fiber is exclusively only the carbon fibers.

8. The form of claim 1 wherein the reinforcement fiber is enriched in carbon fiber in certain regions relative to glass fibers.

9. The form of claim 1 wherein the form is formed using selective commingled fiber bundle positioning (SCFBP), where the form is held together with a thermoplastic stitching.

10. The form of claim 1 wherein said commingled fiber bundle includes recycled fibers.

11. The form of claim 1 further comprising a successive layer formed with said commingled fiber bundle in contact with said two-dimensional layer.

12. The form of claim 11 wherein said optical fiber stitched to said successive layer.

13. The form of claim 11 wherein said first successive layer is angularly displaced relative to said base layer.

14. The form of claim 11 further comprising one to seventeen additional successive layers placed on said first successive layer.

15. The form of claim 11 wherein a plane of symmetry exists among in the form as angular displacement of the layers.

16. A method of forming a unitary reinforced composite component having a sensor system, said method comprising:
placing the form of claim 1 onto a mold platen,
heating the preform to promote fusion of the thermoplastic fibers therein;
cooling the preform until solidified with contours of the component; and
removing the vehicle component from the mold platen.

17. The method of claim 16 further comprising applying a thermoplastic skin intermediate between the form and the mold platen.

18. The method of claim 16 further comprising applying a second opposing platen to apply pressure and sandwich the form.

19. The method of claim 16 wherein the unitary reinforced composite component is a vehicle component.

20. The method of claim 16 further comprising connecting said optical fiber to a Brillouin optical time-domain reflectometer (BOTDR) onboard a vehicle.
